(19) United States
(12) Patent Application Publication
(10) Pub. No.: US 2011/0181984 A1
(43) Pub. Date: Jul. 28, 2011

(54) MAGNETIC RECORDING MEDIUM, MAGNETIC RECORDING AND REPRODUCING APPARATUS, AND METHOD FOR MANUFACTURING MAGNETIC RECORDING MEDIUM

(75) Inventors: Shuichi OKAWA, Tokyo (JP); Narutoshi FUKUZAWA, Tokyo (JP); Takahiro SUWA, Tokyo (JP); Kazuhiro HATTORI, Tokyo (JP); Yoshinori UCHIYAMA, Tokyo (JP)

(73) Assignee: TDK CORPORATION, TOKYO (JP)

(21) Appl. No.: 13/010,065

(22) Filed: Jan. 20, 2011

(30) Foreign Application Priority Data
Jan. 22, 2010 (JP) 2010-12541
Jan. 22, 2010 (JP) 2010-12542

(51) Int. Cl. G11B 5/127; G11B 5/65

(52) U.S. Cl. 360/110; 428/836; G9B/5.04

(57) ABSTRACT

The recording layer is made of both magnetic particles containing Co, Cr, and Pt and a nonmagnetic material containing Cr present among the magnetic particles. The recording element has an uneven Cr distribution such that the ratio of the number of Cr atoms that constitute the recording element to the total number of Co, Cr, and Pt atoms that constitute the recording element is less at the sidewall portion of the recording element than at the center portion of the recording element. The relationships given by Expressions (I) and (II) below are satisfied;

Hnc<Hns (I), and

Hnc/Hcc<Hns/Hcs (II)

where Hns is the nucleation magnetic field of the sidewall portion of the recording element, Hnc is the nucleation magnetic field of the center portion of the recording element, Hcs is the coercive force of the sidewall portion, and Hcc is the coercive force of the center portion.

### TECHNICAL FIELD

The present invention relates to a magnetic recording medium having a recording layer formed in a concavo-convex pattern, a magnetic recording and reproducing apparatus incorporating the same, and a method for manufacturing the magnetic recording medium.

### BACKGROUND ART

Magnetic recording media such as hard disks have been remarkably improved in areal density, for example, by employing finer magnetic particles or alternative materials for recording layers and advanced micro processing for magnetic heads. Although further improvements in areal density are still in demand, these conventional approaches to the improvement of areal density have already reached their limits due to several problems that have come to the surface. These problems include the limited accuracy of micro processing of magnetic heads, erroneous recording of information on tracks adjacent to a target track due to spread of a recording magnetic field produced by the magnetic head, and crosstalk during reproduction operations.

In contrast to this, as candidate magnetic recording media that enable further improvements in areal density, discrete track media or patterned media have been suggested which have a recording layer formed in a concavo-convex pattern and the convex portion of the concavo-convex pattern serves as a recording element (for example, see Patent Literature 1). In these media, the convex portions or recording elements are separated from each other by concave portions. This arrangement improves resistance to erroneous recording of magnetic signals onto another recording element adjacent to a target recording element or crosstalk during reproduction operations. These media are thus expected to contribute to the improvement of areal density. It is also expected that the convex portion of a concavo-convex pattern serving as the recording element in these media will allow the recording magnetic field of the magnetic head to concentrate on the target recording element.

When the magnetic head applies a recording magnetic field to the target recording element, the recording magnetic field tends to be the most intense near the target recording element and abruptly reduced in intensity with increasing distance from the target recording element. However, in practice, the recording magnetic field usually does not have a monotonous distribution and tends to concentrate also on the sidewall portion of another recording element adjacent to the target recording element. Specifically, the recording magnetic field applied to the sidewall portion of another recording element adjacent to the target recording element may be less in strength than the recording magnetic field applied to the target recording element, but greater than the recording magnetic field at the concave portion between that adjacent recording element and the target recording element.

As such, the recording magnetic field has an increased strength at the sidewall portion of another recording element adjacent to the target recording element. Accordingly, this increase in strength reduces the effect, which is to be realized by forming the recording layer in the concavo-convex pattern, of preventing erroneous recording of magnetic signals onto another recording element adjacent to the target recording element.

In contrast to this, there is another known magnetic recording medium with a coercive force of a sidewall portion of its recording element being greater than a coercive force of the other portion of the recording element (for example, see Patent Literature 2). This magnetic recording medium has a granular recording layer with SiO₂ present among magnetic particles. The SiO₂ content of the recording layer is less in the sidewall portion of the recording element than in the other portion of the recording element. This magnetic recording medium is expected to prevent erroneous recording of magnetic signals onto another recording element adjacent to the target recording element by making the coercive force of the sidewall portion of the recording element greater than the coercive force of the other portion of the recording element.

### CITATION LIST

### Patent Literature

Patent Literature 1: Japanese Patent Application Laid-Open No. Hei. 9-97419
Patent Literature 2: Japanese Patent Application Laid-Open No. 2008-135138

### SUMMARY OF INVENTION

### Technical Problem

However, even when the SiO₂ content of the sidewall portion of the recording element was reduced relative to that of the other portion of the recording element, the coercive force of the sidewall portion of the recording element could not always be made greater in practice than the coercive force of the other portion of the recording element.

Moreover, even when the coercive force of the sidewall portion was increased, erroneous recording of magnetic signals onto another recording element adjacent to the target recording element could not be sufficiently prevented once in a while. Furthermore, making the coercive force of the sidewall portion of the recording element greater than the coercive force of the other portion of the recording element can cause the sidewall portion of the target recording element to increase in resistance to magnetization reversal. Accordingly, this would raise another problem that recording on the entire recording element cannot be satisfactorily performed, resulting in magnetic signals being written with reduced reliability.

In view of the foregoing problems, various exemplary embodiments of this invention provide a magnetic recording medium which has a recording layer formed in a concavo-convex pattern and a high areal density, and can store magnetic signals with high reliability. Various exemplary embodiments of this invention also provide a magnetic recording and reproducing apparatus which incorporates the magnetic recording medium.

### Solution to Problem

Various exemplary embodiments of the present invention achieve the aforementioned objects by providing a magnetic recording medium which has a substrate and a recording layer formed over the substrate in a predetermined concavo-convex pattern with a convex portion of the concavo-convex pattern serving as a recording element, wherein the recording layer is made of both magnetic particles containing Co, Cr, and Pt and a nonmagnetic material containing Cr present among the magnetic particles, and the magnetic recording medium has an uneven Cr distribution in the recording element such that the ratio of the number of Cr atoms that constitute the recording element to the total number of Co, Cr, and Pt atoms that constitute the recording element is less at a sidewall portion of the recording element than at a center portion the recording element.

This magnetic recording medium has an uneven Cr distribution in the recording element such that the ratio of the number of Cr atoms that constitute the recording element is less at the sidewall portion of the recording element than at the center portion of the recording element. Therefore, the nucleation magnetic field of the sidewall portion is greater than the nucleation magnetic field of the center portion. Accordingly, the magnetic recording medium has resistance to magnetization reversal in a sidewall portion of another recording element adjacent to a target recording element, the magnetization reversal being caused by a recording magnetic field that is applied to the sidewall portion. Therefore, it is possible to prevent erroneous recording of magnetic signals onto another recording element adjacent to the target recording element.

Furthermore, this magnetic recording medium has an uneven Cr distribution in the recording element such that the ratio of the number of Cr atoms that constitute the recording element is less at the sidewall portion of the recording element than at the center portion of the recording element. This prevents excessive increases in the coercive force of the sidewall portion even in the presence of a great nucleation magnetic field in the sidewall portion. Accordingly, this ensures that recording can be done on the target recording element. The coercive force of the sidewall portion of the recording element is preferably the same as, or less than, the coercive force of the center portion of the recording element.

Moreover, various exemplary embodiments of the present invention achieve the aforementioned objects by providing a magnetic recording medium which has a substrate and a recording layer formed over the substrate in a predetermined concavo-convex pattern with a convex portion of the concavo-convex pattern serving as a recording element, wherein relationships given by Expressions (I) and (II) below are satisfied;

Hnc<Hns (I), and

Hnc/Hcc<Hns/Hcs (II)

where Hns is a nucleation magnetic field of a sidewall portion of the recording element, Hnc is a nucleation magnetic field of a center portion of the recording element, Hcs is a coercive force of the sidewall portion, and Hcc is a coercive force of the center portion.

This magnetic recording medium is configured such that the nucleation magnetic field or the strength of a magnetic field which initiates magnetization reversal satisfies the relationship given by Expression (I). Therefore, the recording magnetic field that is applied to the sidewall portion of a recording element adjacent to a target recording element does not readily cause magnetization reversal in the sidewall portion. Accordingly, it is possible to prevent erroneous recording of magnetic signals onto another recording element adjacent to the target recording element.

Furthermore, this magnetic recording medium ensures recording on the target recording element in spite of a high nucleation magnetic field of the sidewall portion because the relation given by Expression (II) is satisfied to prevent an excessive increase in the coercive force of the sidewall portion.

The coercive force Hcs of the sidewall portion of a recording element is preferably the same as, or less than, the coercive force Hcc of the center portion of the recording element.

Various exemplary embodiments of this invention provide a magnetic recording medium comprising: a substrate; and a recording layer formed over the substrate in a predetermined concave-convex pattern with a convex portion of the concavo-convex pattern serving as a recording element, wherein the recording layer is made of both magnetic particles containing Co, Cr, and Pt and a nonmagnetic material containing Cr present among the magnetic particles, and the recording element has an uneven Cr distribution such that a ratio of a number of Cr atoms that constitute the recording element to a total number of Co, Cr, and Pt atoms that constitute the recording element is less at a sidewall portion of the recording element than at a center portion of the recording element.

Moreover, various exemplary embodiments of this invention provide a method for manufacturing a magnetic recording medium, comprising: a sidewall material deposition step of, using a workpiece having a substrate and a recording layer formed over the substrate in a predetermined concave-convex pattern with a convex portion of the concavo-convex pattern serving as a center portion of a recording element, depositing a material of a sidewall portion of the recording element on the work piece to thereby form the sidewall portion on a side of the center portion, wherein the recording layer is made of both magnetic particles containing Co, Cr, and Pt, and a nonmagnetic material containing Cr present among the magnetic particles, the magnetic recording medium has an uneven Cr distribution in the recording element such that a ratio of a number of Cr atoms that constitute the recording element to a total number of Co, Cr, and Pt atoms that constitute the recording element is less at the sidewall portion of the recording element than at the center portion of the recording element.

Further, various exemplary embodiments of this invention provide a magnetic recording medium comprising: a substrate; and a recording layer formed over the substrate in a predetermined concavo-convex pattern with a convex portion of the concavo-convex pattern serving as a recording element, wherein relationships given by Expressions (I) and (II) below are satisfied;

Hnc<Hns (I), and

Hnc/Hcc<Hns/Hcs (II)

where Hns is a nucleation magnetic field of a sidewall portion of the recording element, Hnc is a nucleation magnetic field of a center portion of the recording element, Hcs is a coercive force of the sidewall portion, and Hcc is a coercive force of the center portion.

Furthermore, various exemplary embodiments of this invention provide a method for manufacturing a magnetic recording medium, comprising: a sidewall material deposition step of, using a workpiece having a substrate and a recording layer formed over the substrate in a predetermined concavo-convex pattern with a convex portion of the concavo-convex pattern serving as a center portion of a recording element, depositing a material of a sidewall portion of the recording element on the work piece to thereby form the sidewall portion on a side of the center portion, wherein the magnetic recording medium satisfies relationships given by Expressions (I) and (II) below;

Hnc<Hns (I), and

Hnc/Hcc<Hns/Hcs (II)

where Hns is a nucleation magnetic field of the sidewall portion of the recording element, Hnc is a nucleation magnetic field of the center portion of the recording element, Hcs is a coercive force of the sidewall portion, and Hcc is a coercive force of the center portion.

Note that as used herein, the phrase “the recording layer formed in a concavo-convex pattern with a convex portion of the concavo-convex pattern serving a recording element” refers to, in addition to a recording layer formed by a continuous recording layer is being divided in a predetermined pattern with convex portions or recording elements completely separated from each other, a recording layer configured such that recording elements separated from each other in the data region are continuous near the boundary between the data region and the servo region, a recording layer which has a recording element formed continuously on part of the substrate such as a recording layer with a recording element formed in a spiral scroll shape, a recording layer which is formed separately on the top of the convex portion and the bottom of the concave portion of the underlying layer formed in a concavo-convex pattern with the part formed on the top of the convex portion serving a recording element, a recording layer which has the concave portion formed halfway in the direction of thickness and is continuous on the bottom of the concave portion, and a continuous recording layer which is deposited in a concavo-convex pattern following the underlying layer formed in a concavo-convex pattern.

Moreover, as used herein, the phrase “the sidewall portion of a recording element” refers to a side surface of the recording element and its neighboring portion.

Furthermore, as used herein, the phrase “the center portion of a recording element” refers to a portion that includes the center of the recording element (in its plan view) and its neighboring portion.

Further, as used herein, the phrase “the ratio of the number of Cr atoms that constitute a recording element to the total number is of Co, Cr, and Pt atoms that constitute the recording element is less at the sidewall portion of the recording element than at the center portion of the recording element” means as follows. That is, this phrase is not limited to a case where Cr is present across the entire recording element, for example, where the sidewall portion of the recording element contains Cr at a lower ratio than the center portion of the recording element or where the ratio of the number of Cr atoms gradually decreases from the center portion of the recording element toward the sidewall portion. Thus, the phrase is also directed to a case where Cr exists substantially only in the center portion of the recording element and no Cr is substantially present in the sidewall portion of the recording element.

Furthermore, as used herein, the term “the magnetic recording medium” refers to, but is not limited to, hard disks, FLOPPY (Registered Trade Mark) disks, or magnetic tapes which employ only magnetism for information recording and reading, as well as magneto-optical recording media such as MOs (Magneto Optical) which employ both magnetism and light in combination, heat-assisted recording media which employ magnetism and heat in combination, and microwave-assisted recording media which employ a combination of magnetism and microwaves.

### Advantageous Effects of Invention

According to various exemplary embodiments of the present invention, it is possible to realize a magnetic recording medium is which has a recording layer formed in a concavo-convex pattern, a high areal density, and a high reliability, and a magnetic recording and reproducing apparatus which incorporates the magnetic recording medium.

### BRIEF DESCRIPTION OF DRAWINGS

FIG. 1 is a perspective view schematically illustrating the general structure of a magnetic recording and reproducing apparatus according to a first exemplary embodiment of the present invention;

FIG. 2 is a cross-sectional view schematically illustrating the structure of a magnetic recording medium of the magnetic recording and reproducing apparatus, when sectioned in parallel to the directions of radius and thickness;

FIG. 3 is an enlarged cross-sectional view illustrating the structure of the recording element and its periphery of the magnetic recording medium, when sectioned in parallel to the directions of radius and thickness;

FIG. 4 is a graph schematically showing an example of magnetic properties of a sidewall portion and a center portion of the recording element of the magnetic recording medium;

FIG. 5 is a graph schematically showing another example of magnetic properties of the sidewall portion and the center portion;

FIG. 6 is an explanatory graph showing changes in magnetic property with decreases in the ratio of the number of Cr atoms;

FIG. 7 is a flowchart showing the outline of the steps of manufacturing the magnetic recording medium;

FIG. 8 is a cross-sectional view schematically illustrating the structure of a starting body of a workpiece in the manufacturing steps, when sectioned in parallel to the directions of radius and thickness;

FIG. 9 is a cross-sectional view schematically illustrating the shape of the workpiece with a resin layer formed in a concavo-convex pattern, when sectioned in parallel to the directions of radius and thickness;

FIG. 10 is a cross-sectional view schematically illustrating the shape of the workpiece with a mask layer processed into a concavo-convex pattern, when sectioned in parallel to the directions of radius and thickness;

FIG. 11 is a cross-sectional view schematically illustrating the shape of the workpiece with a recording layer etched down to its bottom, when sectioned in parallel to the directions of radius and thickness;

FIG. 12 is a cross-sectional view schematically illustrating the shape of the workpiece with the recording layer further processed, when sectioned in parallel to the directions of radius and thickness;

FIG. 13 is a cross-sectional view schematically illustrating the shape of the workpiece with a material of a filler portion deposited on the recording layer, when sectioned in parallel to the directions of radius and thickness;

FIG. 14 is a cross-sectional view schematically illustrating the shape of the workpiece with its surface flattened, when sectioned in parallel to the directions of radius and thickness;

FIG. 15 is a cross-sectional view schematically illustrating the structure of a recording element and its periphery of a magnetic recording medium according to a second exemplary embodiment of the present invention, when sectioned in parallel to the directions of radius and thickness;

FIG. 16 is a flowchart showing the outline of the steps of manufacturing the magnetic recording medium;

FIG. 17 is a cross-sectional view schematically illustrating the shape of a workpiece with a recording layer etched down to its bottom in the process of manufacturing the magnetic recording medium, when sectioned in parallel to the directions of radius and thickness;

FIG. 18 is a cross-sectional view schematically illustrating the shape of the workpiece with a material of a sidewall portion deposited on a recording layer, when sectioned in parallel to the directions of radius and thickness;

FIG. 19 is a cross-sectional view schematically illustrating the shape of the workpiece with a material of a filler portion deposited on the recording layer, when sectioned in parallel to the directions of radius and thickness; and

FIG. 20 is a cross-sectional view schematically illustrating the shape of the workpiece with its surface flattened, when sectioned in parallel to the directions of radius and thickness.

### DESCRIPTION OF EMBODIMENTS

Hereinafter, preferred exemplary embodiments of the present invention will be described in detail with reference to the drawings.

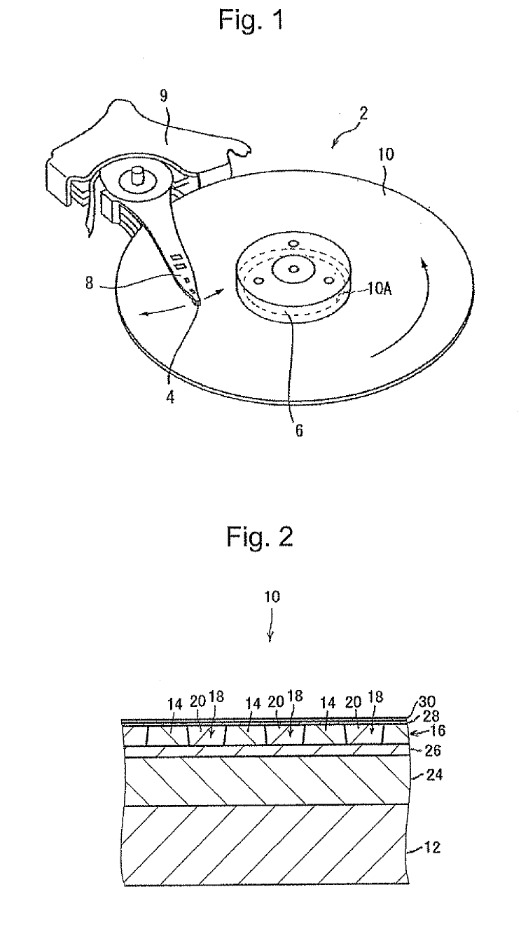

As shown in FIG. 1, a magnetic recording and reproducing apparatus 2 according to a first exemplary embodiment of the present invention includes a magnetic recording medium 10, and a magnetic head 4 which is disposed to be capable of flying in close proximity to the surface of the magnetic recording medium 10 in order to record and reproduce magnetic signals on/from the magnetic recording medium 10.

Note that the magnetic recording medium 10, which has a center hole 10A, is caught by a chuck 6 at the center hole 10A and rotatable along with the chuck 6. Furthermore, the magnetic head 4 is incorporated near the tip of an arm 8, and the arm 8 is pivotably attached to a base 9. This arrangement allows the magnetic head 4 to move in an arc-shaped orbit along the radial direction of the magnetic recording medium 10 in close proximity to the surface of the magnetic recording medium 10.

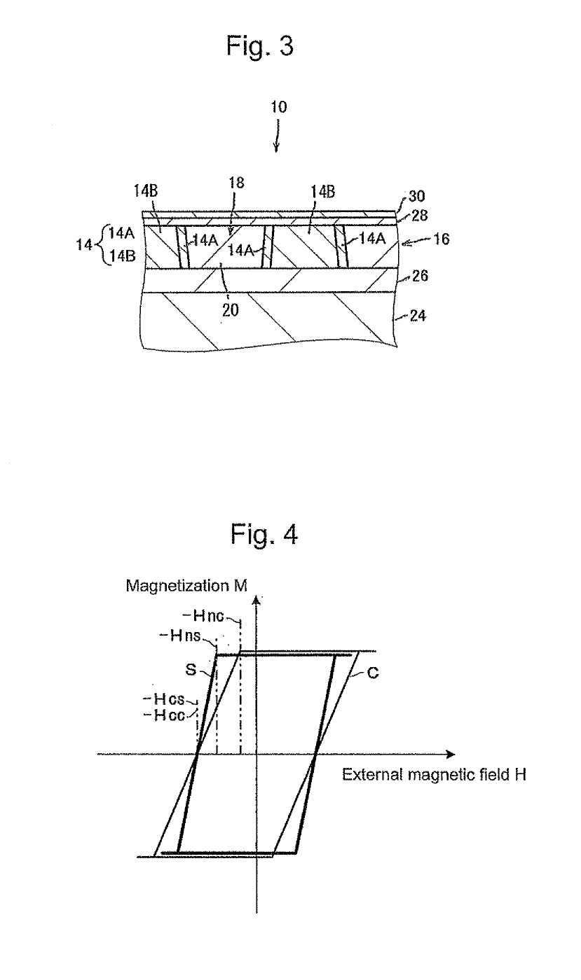

The magnetic recording medium 10, which is a discrete track medium of the perpendicular recording type, is designed as shown in FIGS. 2 and 3. That is, the recording medium 10 includes a substrate 12, and a recording layer 16 which is formed over the substrate 12 in a predetermined concavo-convex pattern with the convex portion of the concave-convex pattern serving as a recording element 14. The recording layer 16 is made of magnetic particles containing Co, Cr, and Pt as well as a nonmagnetic material containing Cr present among those magnetic particles. The magnetic recording medium 10 has an uneven Cr distribution in the recording element 14 such that the ratio of the number of Cr atoms that constitute the recording element 14 to the total number of Co, Cr, and Pt atoms that constitute the recording element 14 is less at the sidewall portion 14A of the recording element 14 than at a center portion 143 of the recording element 14.

The other components and arrangements are thought to be of less importance in understanding the first exemplary embodiment and therefore will be omitted as appropriate.

The magnetic recording medium 10 includes a soft magnetic layer 24, a seed layer 26, the recording layer 16, a protective layer 28, and a lubricant layer 30, which are formed in that order over the substrate 12.

The substrate 12 is formed generally in the shape of a disk with a center hole. The substrate 12 can be made of glass, Al, Al₂O₃, or the like.

The recording layer 16 is 5 to 30 nm in thickness. The recording layer 16 has convex portions or multiple recording elements 14, which are each formed in the shape of a concentric arc and radially spaced apart from each other at minute intervals in the data region. FIGS. 2 and 3 show a cross-sectional view of these recording elements 14. The recording element 14 has a radial width of 10 to 100 nm on its top surface in the data region. Furthermore, the recording layer 16 has a concave portion 18 in its concavo-convex pattern. The concave portion 18 is 10 to 100 nm in width in the radial direction at the level of the top surface of the recording element 14. Note that the recording element 14 is formed in a predetermined servo pattern in the servo region (not shown).

The magnetic particles of the recording layer 16 substantially consist of Co, Cr, and Pt, for example. The nonmagnetic material of the recording layer 16, which is present among the magnetic particles, substantially consists of an oxide-based material such as SiO₂ or TiO₂, and Cr.

For example, the sidewall portion 14A is a portion which is up to 1-10 nm from the side surface of the recording element 14. In the first exemplary embodiment, the center portion 14B is the other portion than the sidewall portion 14A in the recording element 14.

For example, the Cr content of the sidewall portion 14A (the number of Cr atoms that constitute the sidewall portion 14A to the total number of Co, Cr, and Pt atoms that constitute the sidewall portion 14A) may be preferably 12% or less.

On the other hand, for example, the Cr content of the center portion 143 (the number of Cr atoms that constitute the center portion 14B to the total number of Co, Cr, and Pt atoms that constitute the center portion 14B) may be preferably in the range is of 15 to 25%.

Furthermore, the Cr content of the sidewall portion 14A may be preferably 90% or less than the Cr content of the center portion 14B. Moreover, the Cr content of the sidewall portion 14A may be 80% or less than the Cr content of the center portion 14B. Further, the Cr content of the sidewall portion 14A may be 70% or less than the Cr content of the center portion 14B. Furthermore, the Cr content of the sidewall portion 14A may be 60% or less than the Cr content of the center portion 143. The Cr content of the sidewall portion 14A may be 50% or less than the Cr content of the center portion 14B. Note that the sidewall portion 14A has the same crystal structure as that of the center portion 14B.

The concave portion 18 of the recording layer 16 is filled with a filler portion 20. The filler portion 20 can be made of an oxide such as SiO₂, Al₂O₃, TiO₂, MgO, ZrO₂, or ferrite; a nitride such as AlN; a carbide such as SiC; DLC (diamond like carbon); a nonmagnetic metal such as Cu, Cr, or Ti; or a resin material. The recording element 14 and the filler portion 20 each have a generally flat top surface.

The soft magnetic layer 24 is 20 to 300 nm in thickness. The soft magnetic layer 24 can be made of an Fe alloy, Co alloy or the like.

The seed layer 26 is 2 to 40 nm in thickness. The seed layer 26 can be made of a nonmagnetic CoCr alloy, Ti, Ru, a layered structure of Ru and Ta, MgO or the like.

The protective layer 28 is 1 to 5 nm in thickness. The protective layer 28 can be made of DLC (diamond like carbon).

The lubricant layer 30 is 1 to 2 nm in thickness. The lubricant layer 30 can be made of PFPE (perfluoropolyether).

Now, a description will be made to the operation of the magnetic recording medium 10.

The magnetic recording medium 10 has an uneven Cr distribution in the recording element 14 such that the ratio of the number of Cr atoms that constitute the recording element 14 is less at the sidewall portion 14A of the recording element 14 than at the center portion 14B of the recording element 14. Therefore, the nucleation magnetic field of the sidewall portion 14A is greater than the nucleation magnetic field of the center portion 14B. That is, the nucleation magnetic field Hns of the sidewall portion 14A of the recording element 14 and the nucleation magnetic field Hnc of the center portion 14B of the recording element 14 satisfy the relationship given by Expression (I) below:

Hnc<Hns (I).

Accordingly, it is unlikely that a recording magnetic field applied to the sidewall portion 14A of another recording element 14 adjacent to a target recording element 14 causes magnetization reversal in the sidewall portion 14A. This makes it possible to prevent erroneous recording of magnetic signals onto another recording element 14 adjacent to the target recording element 14.

Furthermore, the magnetic recording medium 10 has an uneven Cr distribution in the recording element 14 such that the ratio of the number of Cr atoms that constitute the recording element 14 is less at the sidewall portion 14A of the recording element 14 than at the center portion 14B of the recording element 14. This arrangement allows for preventing the sidewall portion 14A from excessively increasing in the coercive force even in the presence of a high nucleation magnetic field of the sidewall portion 14A. For example, the nucleation magnetic field Hns of the sidewall portion 14A of the recording element 14, the nucleation magnetic field Hnc of the center portion 14B of the recording element 14, the coercive force Hcs of the sidewall portion 14A, and the coercive force Hcc of the center portion 14B satisfy the relationship given by Expression (II) below:

Hnc/Hcc<Hns/Hcs (II).

As such, the magnetic recording medium 10 satisfies the relationship given by Expression (II), so that an excessive increase of coercive force in the sidewall portion 14A is prevented even in the presence of a high nucleation magnetic field of the sidewall portion 14A. This can ensure recording on the target recording element 14. Note that as used herein, Hns, Hcs, Hnc, and Hcc have the absolute value of a nucleation magnetic field or coercive force.

Furthermore, it is possible to make the nucleation magnetic field Hns of the sidewall portion 14A of the recording element 14 greater than the nucleation magnetic field Hnc of the center portion 14B of the recording element 14 without allowing the coercive force is Hcs of the sidewall portion 14A of the recording element 14 to be greater than the coercive force Hcc of the center portion 14B of the recording element 14. This is because the sidewall portion 14A has a relatively low Cr content, whereas the center portion 14B has a relatively high Cr content.

By the way, assume that the magnetic anisotropy constant Ku of the magnetic particles is increased uniformly across the recording element 14 to uniformly increase the nucleation magnetic field Hn, for example. In this case, note that the coercive force Hc is also increased across the recording element 14, thereby causing the entire recording element 14 to have further increased resistance to recording of magnetic signals.

Alternatively, assume that the magnetic anisotropy constant Ku of the magnetic particles is increased uniformly across the recording element 14, and further that the exchange coupling between the magnetic particles is enhanced to increase the nucleation magnetic field Hn uniformly while an increase in the coercive force Hc is uniformly prevented (i.e. Hn/Hc is uniformly increased). In this case, the magnetic particles depend on each other to readily cause magnetization reversal, thereby making it difficult to improve the areal density in the circumferential direction of the track.

The direction of magnetization of the sidewall portion 14A readily follows the direction of magnetization of the center portion 14B. Thus, the areal density in the circumferential direction of the track can be prevented from being reduced even when the exchange coupling between the magnetic particles of the sidewall portion 14A is enhanced.

For example, the sidewall portion 14A of the recording element 14 has a coercive force Hcs of 3 to 15 kOe. Hcs is preferably 3 to 6 kOe. On the other hand, for the heat-assisted type, Hcs is preferably 6 to 15 kOe.

For example, the sidewall portion 14A of the recording element 14 has a nucleation magnetic field Hns of 1.6 to 13 kOe. Hns is preferably 1.6 to 5 kOe. Meanwhile, for the heat-assisted type, Hns is preferably 3.3 to 13 kOe.

For example, the center portion 14B of the recording element 14 has a coercive force Hcc of 3 to 15 kOe. Hcc is preferably 3 to 6 kOe. Meanwhile, for the heat-assisted type, Hcc is preferably 6 to 15 kOe.

For example, the center portion 14B of the recording element 14 has a nucleation magnetic field Hnc of 1.5 to 9 kOe. Hnc is preferably 1.5 to 3.5 kOe. Meanwhile, for the heat-assisted type, Hnc is preferably 3 to 9 kOe.

Hns/Hcs is, for example, 0.5 to 0.8. Furthermore, Hnc/Hcc is, for example, 0.4 to 0.6.

In addition to Expression (II) above, the coercive force Hcs of the sidewall portion 14A of the recording element 14 and the coercive force Hcc of the center portion 14B preferably satisfy the relationships given by Expression (III) or (IV) below:

Hcc=Hcs (III), or

Hcc>Hcs (IV).

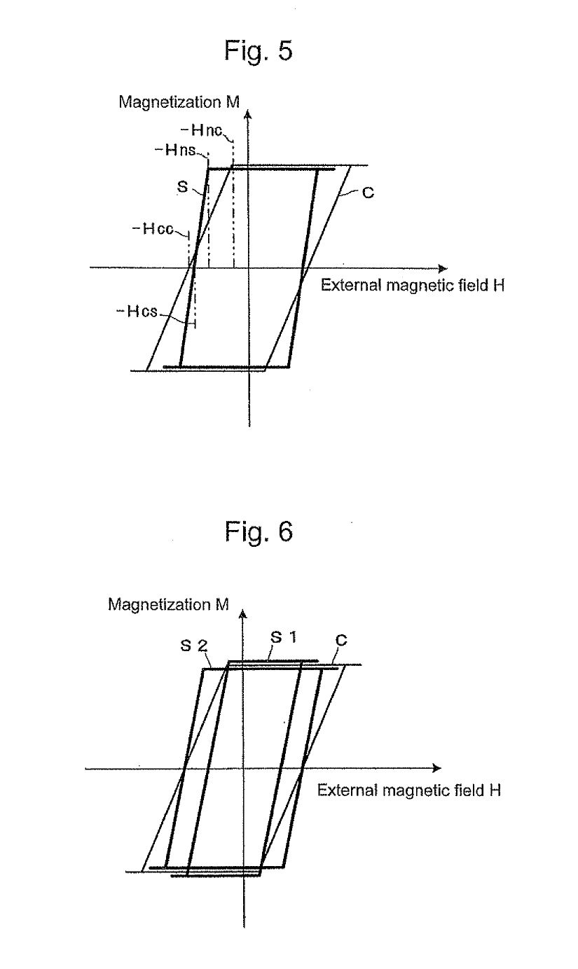

FIG. 4 is a graph schematically illustrating an example of the magnetic properties of the sidewall portion 14A and the center portion 143, which satisfies the relationships given by Expressions (I), (II), and (III). Furthermore, FIG. 5 is a graph schematically illustrating another example of the magnetic properties of the sidewall portion 14A and the center portion 14B, which satisfies the relationships given by Expressions (I), (II) and (IV).

Note that in FIGS. 4 and 5, the horizontal axis represents the external magnetic field and the vertical axis represents the magnetization. FIGS. 4 and 5 show the hysteresis loop, denoted with symbol S, which is the magnetic property of the sidewall portion 14A as well as the hysteresis loop, denoted with symbol C, which is the magnetic property of the center portion 14B. In FIGS. 4 and 5, the maximum or minimum of magnetization value (the vertical axis) of the hysteresis loop denoted with symbol S and the maximum or minimum of magnetization value (the vertical axis) of the hysteresis loop denoted with symbol C are plotted with slight space therebetween for clarity of illustration. This also holds true for FIG. 6 which will be described later.

As shown in FIGS. 4 and 5, the nucleation magnetic field Hns and the coercive force Hcs of the sidewall portion 14A satisfy the relationship below:

Hns<Hcs.

Furthermore, the nucleation magnetic field Hnc and the coercive force Hcc of the center portion 14B also satisfy the relationship below:

Hnc<Hcc.

The nucleation magnetic field Hns of the sidewall portion 14A of the recording element 14 and the nucleation magnetic field Hnc of the center portion 14B of the recording element 14 preferably satisfy the relationship given by Expression (V) below, and more preferably satisfy either one of the relationships given by Expressions (VI) to (IX) below:

1.1×Hnc<Hns (V),

1.2×Hnc<Hns (VI),

1.3×Hnc<Hns (VII),

1.4×Hnc<Hns (VIII), and

1.5×Hnc<Hns (IX).

Furthermore, Hnc/Hcc and Hns/Hcs preferably satisfy the relationship given by Expression (X) below, and more preferably satisfy either one of the relationships given by Expressions (XI) to (XIV) below:

1.1×Hnc/Hcc<Hns/Hcs (X),

1.2×Hnc/Hcc<Hns/Hcs (XI),

1.3×Hnc/Hcc<Hns/Hcs (XII),

1.4×Hnc/Hcc<Hns/Hcs (XIII), and

1.5×Hnc/Hcc<Hns/Hcs (XIV).

As described above, the ratio of the number of Cr atoms is relatively low at the sidewall portion 14A, whereas the ratio of the number of Cr atoms is relatively high at the center portion 14B. In this case, the nucleation magnetic field of the sidewall portion 14A is greater than the nucleation magnetic field of the center portion, and the sidewall portion 14A is prevented from excessively increasing in the coercive force even in the presence of a high nucleation magnetic field of the sidewall portion 14A. The reasons for this have not been fully understood, but can be generally explained as follows.

To improve the areal density, the magnetic domain used to record one bit needs to be reduced in size. Reducing the size of the magnetic domain requires the reduction of the size of magnetic particles as well as the prevention of coupling between magnetic particles. This is because a stronger coupling between magnetic particles causes the magnetization of peripheral magnetic particles, which surround target magnetic particles whose magnetization reversal is desired, to be more easily reversed. This magnetization reversal of peripheral magnetic particles occurs, even though it is not intended, following the magnetization reversal of the target magnetic particles. If the coupling between magnetic particles is so weak as negligible, the magnetization of each magnetic particle is reversed according to its own coercive force. The stronger the coupling between magnetic particles is, the easier the magnetization reversal of a magnetic particle becomes following the magnetization reversal of another magnetic particle. The magnetic particles are separated from each other by materials present between the particles to reduce their coupling force, thereby made easier to be independently reversed in magnetization.

The nucleation magnetic field Hn is governed by the magnetic anisotropy of magnetic particles, so that the greater the magnetic anisotropy is (the greater the magnetic anisotropy constant Ku is), the greater the nucleation magnetic field Hn becomes. On the other hand, the coercive force Hc is governed by the strength of the exchange coupling between magnetic particles as well as the magnetic anisotropy of magnetic particles. Thus, the greater the magnetic anisotropy of magnetic particles is (the greater the magnetic anisotropy constant Ku is), the greater the coercive force Hc is, and the stronger the exchange coupling between magnetic particles is, the weaker the coercive force Hc is.

Cr is found within magnetic particles along with CoPt, and Cr is also found between the magnetic particles along with SiO₂ or TiO₂.

Cr contributes to the separation of the magnetic particles between the magnetic particles in conjunction with SiO₂ or TiO₂. The smaller the ratio of the number of Cr atoms between the magnetic particles is, the stronger the coupling between the magnetic particles is. Thus, a magnetization reversal of a magnetic particle is readily followed by magnetization reversal of peripheral magnetic particles. That is, the smaller the ratio of the number of Cr atoms between magnetic particles is, the less (the is absolute value of) the coercive force of the recording layer tends to become. However, the ratio of the number of Cr atoms between magnetic particles has almost no effects on (the absolute value of) the nucleation magnetic field of the magnetic particles which will trigger magnetization reversal. As schematically shown in FIG. 6, when the ratio of the number of Cr atoms between magnetic particles is reduced, the magnetic property changes from the hysteresis loop denoted with symbol C to the hysteresis loop denoted with symbol S1.

On the other hand, Cr has effects on the magnetic anisotropy of magnetic particles within the magnetic particles along with CoPt. The smaller the ratio of the number of Cr atoms within the magnetic particles is, the greater the magnetic anisotropy of magnetic particles becomes (the greater the magnetic anisotropy constant Ku becomes). Thus, individual magnetic particles have further enhanced resistance to magnetization reversal. That is, the smaller the ratio of the number of Cr atoms within magnetic particles is, the higher (the absolute value of) the nucleation magnetic field as well as the greater (the absolute value of) the coercive force tend to be. As schematically shown in FIG. 6, when the ratio of the number of Cr atoms in magnetic particles is reduced, the magnetic property changes from the hysteresis loop denoted with symbol S1 to the hysteresis loop denoted with symbol 52.

Note that as in FIG. 4, FIG. 6 shows an example in which the coercive force of the hysteresis loop (an intersection with the horizontal axis) denoted with symbol C coincides with the coercive force of the hysteresis loop denoted with symbol 52. However, depending on deposition conditions or the like, the coercive force of the hysteresis loop denoted with symbol S2 may be slightly less than the coercive force of the hysteresis loop denoted with symbol C as shown in FIG. 5. Alternatively, depending on deposition conditions or the like, the coercive force of the hysteresis loop denoted with symbol S2 may be slightly higher than the coercive force of the hysteresis loop denoted with symbol C.

By the way, assume that the ratio of the number of Cr atoms contained in magnetic particles across the recording element 14 is reduced, and the magnetic anisotropy constant Ku of the magnetic particles is uniformly increased to uniformly increase the nucleation magnetic field Hn, for example. In this case, note that the coercive force Hc is also increased across the recording element 14, thereby causing the entire recording element 14 to have further increased resistance to recording of magnetic signals.

Alternatively, assume that the magnetic anisotropy constant Ku of the magnetic particles is uniformly increased across the recording element 14, and further that the exchange coupling between the magnetic particles is enhanced by reducing the ratio of the number of Cr atoms in nonmagnetic materials present among the magnetic particles to increase the nucleation magnetic field Hn uniformly while an increase in the coercive force Hc is uniformly prevented (i.e., Hn/Hc is uniformly increased). In this case, the magnetic particles depend on each other to readily cause magnetization reversal, thereby making it difficult to improve the areal density in the circumferential direction of the track.

The direction of magnetization of the sidewall portion 14A readily follows the direction of magnetization of the center portion 14B. Accordingly, the areal density in the circumferential direction of the track could be prevented from being reduced even when the ratio of the number of Cr atoms of the sidewall portion 14A is reduced to enhance the exchange coupling between the magnetic particles of the sidewall portion 14A.

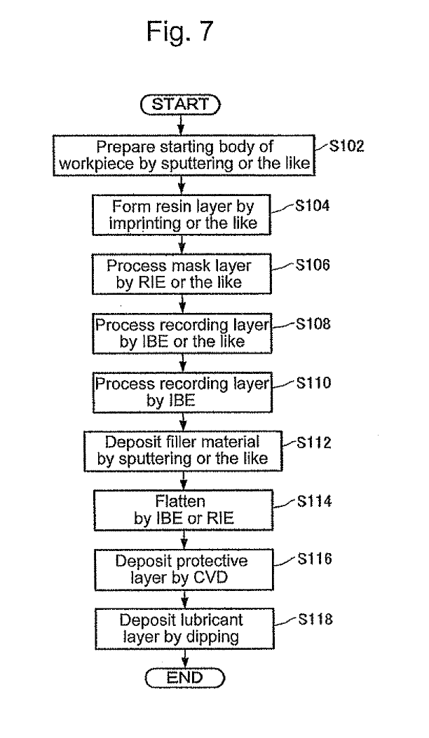

Now, a description will be made to a method for manufacturing the magnetic recording medium 10 with reference to the flowchart shown in FIG. 7.

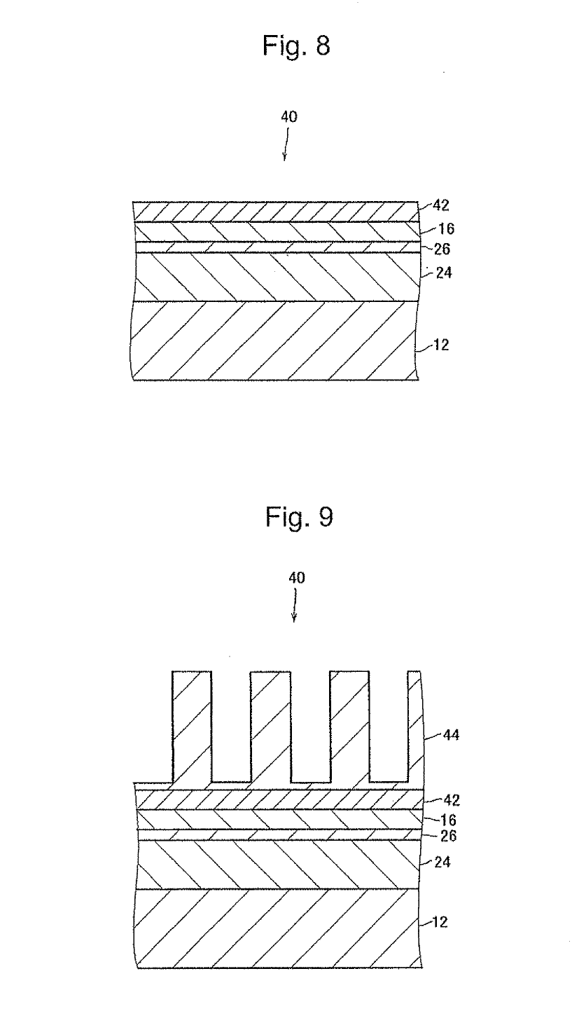

In the first step, the starting body of a workpiece 40 as shown in FIG. 8 is prepared (S102: a starting body of a workpiece preparing step). The starting body of the workpiece 40 is obtained by depositing the soft magnetic layer 24, the seed layer 26, the recording layer 16 (which is continuous before being processed into a concavo-convex pattern), and a mask layer 42 over the substrate 12 in that order by a sputtering method or the like. Here, the recording layer 16 is made of both ferromagnetic particles containing Co, Cr, and Pt, and a nonmagnetic material containing Cr and SiO₂ or TiO₂ present among the magnetic particles.

The mask layer 42 is 2 to 50 nm in thickness. The mask layer 42 can be made of a material, such as DLC, whose main component is C (carbon).

Then, a resin material is applied onto the mask layer 42 of the workpiece 40 by spin coating, and further a stamper (not shown) is employed to transfer, to the resin material, a concavo-convex pattern corresponding to the concavo-convex pattern of the recording layer 16 by imprinting. As shown in FIG. 9, this leads to the formation of a resin layer 44 in the concavo-convex pattern (S104: a resin layer forming step). As the imprinting method, the process can employ optical imprinting using ultraviolet radiation or thermal imprinting. For optical imprinting, the resin layer 44 can be made of a ultraviolet curable resin. On the other hand, for thermal imprinting, the resin layer 44 can be made of a thermoplastic resin. For example, the resin layer 44 is 10 to 300 nm in thickness (the thickness of the convex portion). Note that the resin layer 44 under the bottom of the concave portion is removed by aching or the like. Furthermore, using photosensitive resist or electron-beam resist as the resin material, the optical lithography or electron-beam lithography may be employed to form the resin layer 44 in a concavo-convex pattern corresponding to the concave-convex pattern of the recording layer 16.

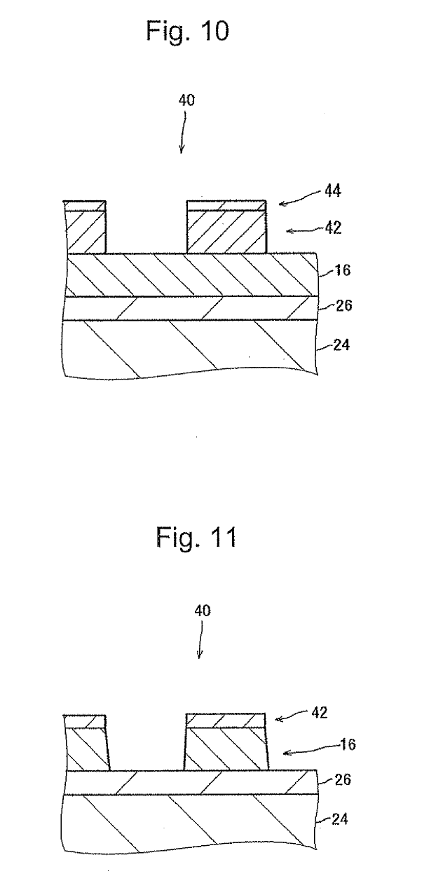

Next, the mask layer 42 under the bottom of the concave portion is removed by RIE (Reactive Ion Etching) using a halogen-based gas or an O₂ gas (S106: a mask layer processing step). As shown in FIG. 10, this step exposes a portion of the top surface of the recording layer 16, the portion being associated with the concave portion 18.

Then, as shown in FIG. 11, by IBE (Ion Beam Etching) using a rare gas such as an Ar gas, the recording layer 16 under the bottom of the concave portion is removed down to the lower level (at which it contacts with the seed layer 26) (S108: a recording layer firstly processing step). This step forms the recording layer 16 in the shape that corresponds to multiple recording elements 14. In this step, for example, the beam voltage (grid voltage) for IBE is set at 500 to 1000 V.

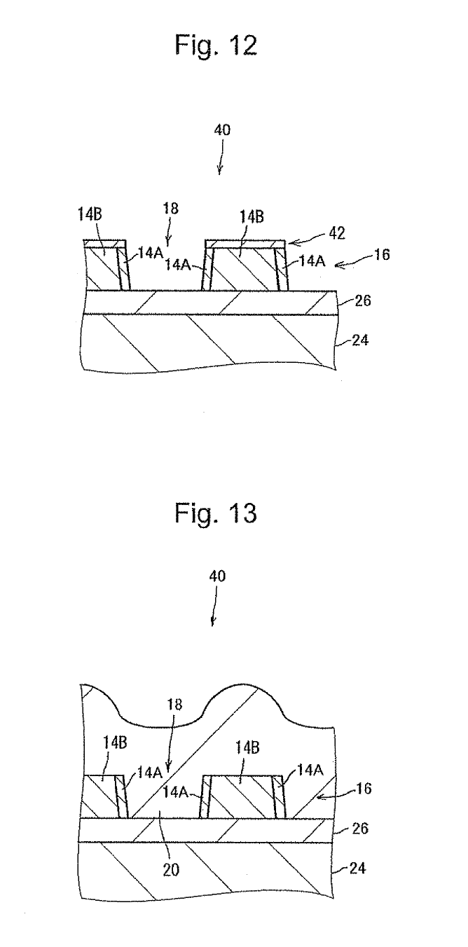

Next, by IBE using a rare gas such as an Ar gas, the side surfaces of the concave portion of the recording layer 16 are irradiated with a rare gas (S110: a recording layer secondly processing step). In this step, the IBE beam voltage is set to a lower value than in the recording layer firstly processing step (S108). For example, the IBE beam voltage is set at 100 to 300 V. In this step (S110), part or the whole of the seed layer 26 under the bottom of the concave portion may be removed (not shown). As such, as shown in FIG. 12, the recording layer 16 in the concavo-convex pattern which has been divided into the multiple recording elements 14 (the sidewall portion 14A and the center portion 14B) is formed. In the recording layer secondly processing step (S110), the IBE beam voltage is set at a lower value than in the recording layer firstly processing step (S108). This causes lighter elements of those that constitute the recording layer 16 to be etched with a higher priority. Cr, which is lighter than Co and Pt, is removed with a higher priority when compared with Co and Pt. This causes the side surfaces of the recording element 14 and their neighboring portions to have a lower ratio of the number of Cr atoms than the other portions. This results in the sidewall portion 14A being formed to have a relatively low ratio of the number of Cr atoms and the center portion 14B being formed to have a relatively high ratio. The mask layer 42 remaining on top of the recording element 14 is removed by IBE or RIE using an O₂ gas or a gas containing nitrogen or hydrogen such as a N₂ gas, NH₃ gas, or H₂ gas.

Note that as used herein, the term “IBE” collectively refers to processing methods, such as ion milling, for irradiating a workpiece with an ionized gas to remove components to be processed. Furthermore, in the subject application, even when the process employs a gas like a rare gas that does not chemically react with components to be processed, the term “RIE” will also be used to refer to etching using an RIE apparatus.

Now, as shown in FIG. 13, by sputtering or bias sputtering, the material of the filler portion 20 is deposited on the workpiece 40 having the recording layer 16 in the concavo-convex pattern to form the filler portion 20 in the concave portion 18 between the recording elements 14 (S112: a filler material depositing step). Note that the material of the filler portion 20 is also deposited on the recording elements 14 so as to cover the recording layer 16.

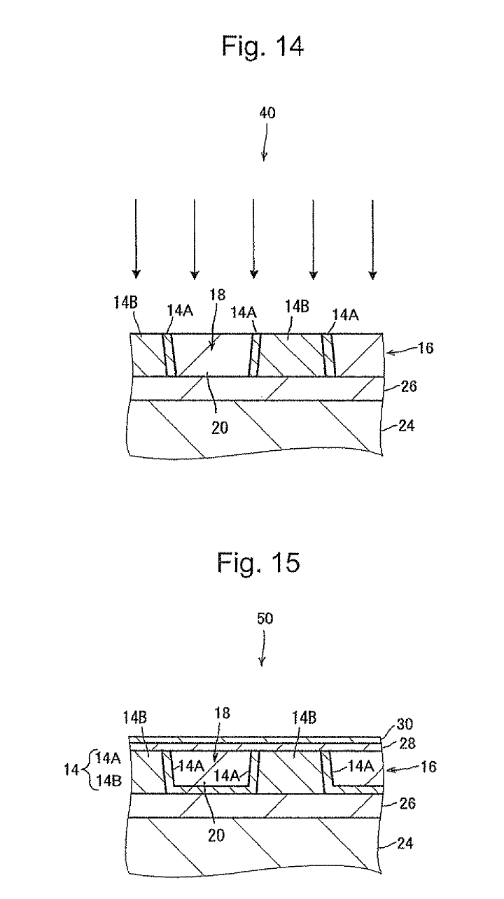

Then, as shown in FIG. 14, by IBE or RIE using a rare gas such as an Ar gas, an excessive portion of the material of the filler portion 20 is removed to flatten the surface of the workpiece 40 (S114: a flattening step). Note that as used herein, the expression “the excessive portion of the material of the filler portion 20” refers to the portion of the deposited material of the filler portion 20 that locates on upper side (opposite side to the substrate 12) of the level of the top surface of the recording element 14. The arrows in FIG. 14 schematically show the direction of the irradiating process gas.

Next, by CVD, the protective layer 28 is formed over the recording element 14 and the filler portion 20 (S116: a protective layer forming step). Furthermore, by dipping, this process is followed by forming the lubricant layer 30 on the protective layer 28 (S118: a lubricant layer forming step). In this manner, the magnetic recording medium 10 shown in FIGS. 2 and 3 is completed.

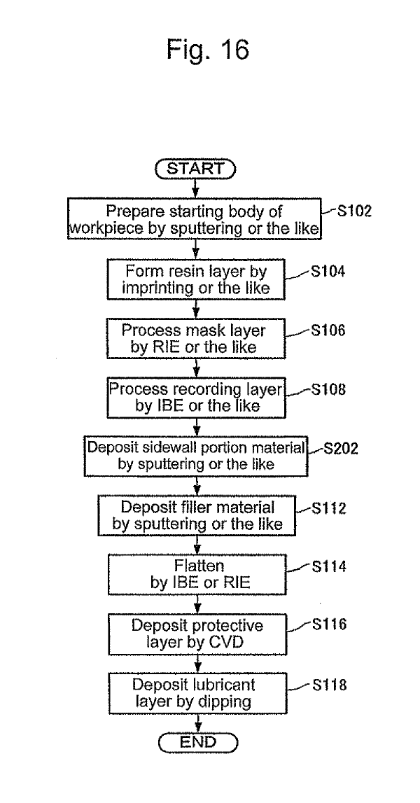

Now, a description will be made to a second exemplary embodiment of the present invention. As shown in FIG. 15, the second exemplary embodiment relates to a magnetic recording medium 50 in which the material of the sidewall portion 14A is also formed on the bottom of the concave portion 18. The first exemplary embodiment employs two steps for processing the recording layer 16, i.e., the recording layer firstly processing step (S108) and the recording layer secondly processing step (S110). The recording layer secondly processing step (S110) sets the IBE beam at a lower voltage than the recording layer firstly processing step (S108). This allows for forming the sidewall portion 14A which has a relatively low Cr content and the center portion 14B which has a relatively high Cr content. In contrast, as shown in the flowchart of FIG. 16, the second exemplary embodiment employs only the recording layer firstly processing step (S108) to process the recording layer 16 to form solely the center portion 14B. After that, the material of the sidewall portion 14A is deposited (S202: a sidewall portion material depositing step) to form the sidewall portion 14A. Note that in the resin layer forming step (S104), the resin layer 44 is formed in a concavo-convex pattern corresponding to a concavo-convex pattern which includes not the sidewall portion 14A but only the center portion 14B as the convex portion. The other points than those mentioned above are the same as those of the first exemplary embodiment and will thus not be repeatedly explained but only shown with the same reference signs as those of FIGS. 1 to 14.

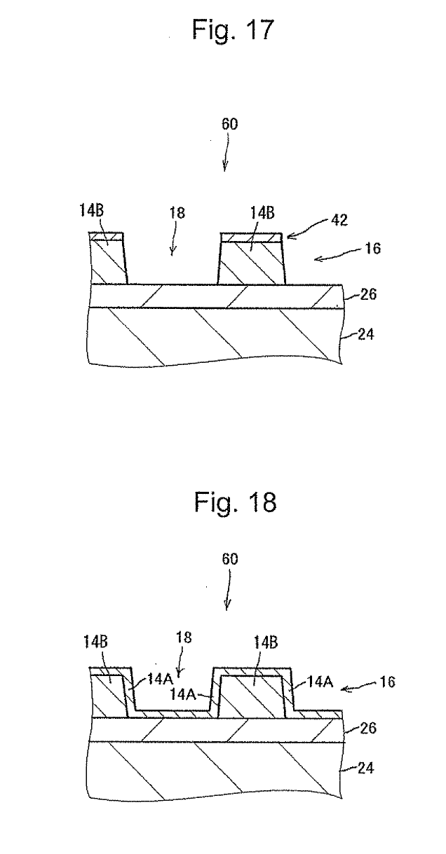

As shown in FIG. 17, in the recording layer firstly processing step (S108), the recording layer 16 of a workpiece 60 is etched down to its bottom surface. In this manner, the center portion 14B is formed. Note that the mask layer 42 remaining on top of the recording element 14 is removed by IBE or RIE using an O₂ gas, or a gas containing nitrogen or hydrogen such as a N₂ gas, NH₃ gas, or H₂ gas.

Next, as shown in FIG. 18, by sputtering or bias sputtering, the material of the sidewall portion 14A is deposited on the workpiece 60 of the concavo-convex pattern with only the center portion 14B formed so as to conform to the concavo-convex pattern, thereby forming the sidewall portion 14A on the side surfaces of the center portion 14B (S202). Like the material of the center portion 14B, the material of the sidewall portion 14A contains magnetic particles containing Co, Cr, and Pt, and a nonmagnetic material containing Cr and SiO₂ or TiO₂ present among the magnetic particles. Meanwhile, the material of the sidewall portion 14A has a lower ratio of the number of Cr atoms than the material of the center portion 14B. The material of the sidewall portion 14A deposited is, for example, 1 to 10 nm in thickness. Note that the material of the sidewall portion 14A is also deposited on the center portion 14B. Furthermore, the material of the sidewall portion 14A is also deposited on the bottom of the concave portion 18. The material of the sidewall portion 14A has the same crystal structure as that of the material of the center portion 14B, so that the material of the sidewall portion 14A deposited has a good crystallinity.

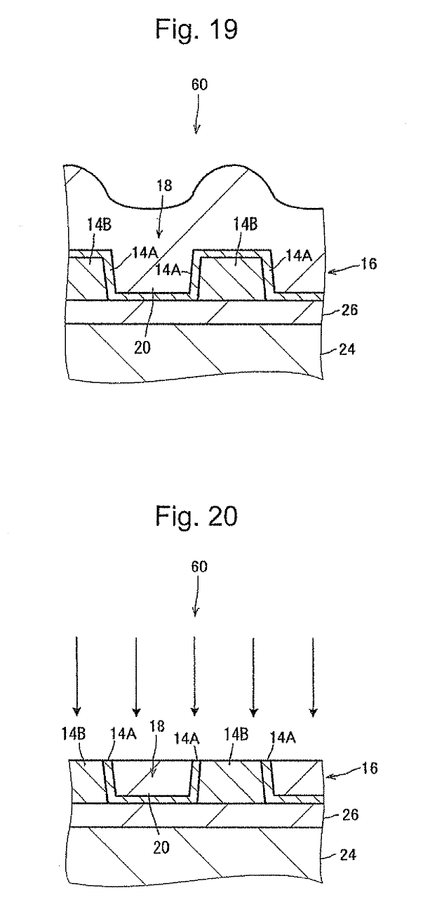

Then, as shown in FIG. 19, by sputtering or bias sputtering, the material of the filler portion 20 is deposited over the material of the sidewall portion 14A to form the filler portion 20 in the concave portion 18 between the recording elements 14 (S112). Note that the material of the filler portion 20 is also deposited on the sidewall portion 14A and the center portion 14B so as to cover the recording layer 16.

Next, as shown in FIG. 20, by IBE or RIE using a rare gas such as an Ar gas, the process removes the excessive portions of the material of the sidewall portion 14A and the material of the filler portion 20 to flatten the surface of the workpiece 60 (S114). Note that as used herein, the phrase “the excessive portions of the material of the sidewall portion 14A and the material of the filler portion 20” refers to the portions of the deposited materials of the sidewall portion 14A and the filler portion 20 that locates on upper side (opposite side to the substrate 12) of the level of the top surface of the center portion 14B.

Hereafter, like the first exemplary embodiment, the protective layer forming step (S116) and the lubricant layer forming step (S118) are followed to complete the magnetic recording medium 50 shown in FIG. 15.

Note that in the first and second exemplary embodiments, the soft magnetic layer 24 and the seed layer 26 are formed under the recording layer 16. However, the configuration of the layers underlying the recording layer 16 can be changed as appropriate depending on the type of the magnetic recording medium. For example, an underlayer or an antiferromagnetic layer may be formed between the soft magnetic layer 24 and the substrate 12. Furthermore, either one or both of the soft magnetic layer 24 and the seed layer 26 may be eliminated. Furthermore, the recording layer may be formed directly on the substrate.

Furthermore, in the first and second exemplary embodiments, the mask layer 42 and the resin layer 44 are formed over the recording layer 16 having a continuous film. However, the materials of the mask layers and the resin layer, the number of mask and/or resin layers to be stacked, the thicknesses of the layers, and the types of dry etching are not particularly limited as long as the recording layer 16 can be processed with a highly precise shape.

Furthermore, in the first and second exemplary embodiments, by IBE or RIE using a rare gas such as an Ar gas, the excessive portions of the material of the filler portion 20 and the material of the sidewall portion 14A are removed to flatten the surface of the workpiece 40 (60). However, for example, by another method such as CMP, the surface of the workpiece 40 (60) may be flattened.

Furthermore, in the first and second exemplary embodiments, the magnetic recording medium 10 (50) is a perpendicular recording type discrete track medium in which the recording layer 16 is divided at minute intervals in the radial direction of the track. However, various exemplary embodiments of the present invention are also applicable to a patterned medium which is divided at minute intervals in both the radial and circumferential directions of the track, a magnetic disk having a spiral-shaped recording layer, and a magnetic disk having a recording layer which has a concave portion formed halfway in the direction of thickness and is continuous at the bottom. Furthermore, various exemplary embodiments of the present invention are also applicable to the longitudinal recording type magnetic disk. Furthermore, various exemplary embodiments of the present invention are also applicable to a double-sided magnetic recording medium with a recording layer or the like formed on both sides of the substrate. Furthermore, the present invention is also applicable to magneto-optical disks such as MOs, heat-assisted magnetic disks which employ magnetism and heat in combination, microwave-assisted magnetic disks which employ a combination of magnetism and microwaves. The present invention is further applicable to magnetic recording media, such as magnetic tapes of other than the disk shape, which have a recording layer in a concavo-convex pattern.

Furthermore, in the first and second exemplary embodiments, the magnetic particles of the recording layer 16 substantially consist of Co, Cr, and Pt, for example. The nonmagnetic material of the recording layer 16, which is present among the magnetic particles substantially consists of an oxide-based material such as SiO₂ or TiO₂ and Cr, for example. However, a combination of the materials of the sidewall portion 14A and the center portion 14B is not particularly limited so long as it satisfies Expressions (I) and (II) above. Specifically, the sidewall portion 14A and the center portion 14B can be formed of materials other than a CoCrPt alloy, for example, a CoPt based alloy, a FePt based alloy, or a stacked body of these alloys. It is also possible to employ materials with MgO, Al₂O₃, AlN, SiO₂, Ag, or Au present among ferromagnetic particles of a FePt based alloy such as FePtCu, FePtZr, FePtB, or FePtZr. Note that to employ these materials, a material having the same crystal structure as that of the center portion 14B is preferably used as the material of the sidewall portion 14A in order to provide a good crystallinity to the material of the sidewall portion 14A deposited.

### Working Example 1

Following the method for manufacturing magnetic recording media described in the first exemplary embodiment, the magnetic recording medium 10 was prepared. Specifically, in the starting body of a workpiece 40 preparing step (S102), the recording layer 16 was deposited in a thickness of 20 nm. The deposited recording layer was a CoCrPt film with SiO₂ present among magnetic particles. Specifically, the material of the deposited recording layer was substantially consisting of Co, Cr, Pt, and SiO₂. Hereinafter, such a material will be represented as CoCrPt—SiO₂. More specifically, the material that had a composition formula of CO₂₄₀Cr₇₂Pt₈₈SiO₂ ((CO₆₀Cr₁₈Pt₂₂)₈₀(SiO₂)₂₀) was deposited. The mask layer 42 was also deposited in a thickness of 20 nm. Note that the substrate 12 had a diameter of 65 mm.

In the resin layer forming step (S104), using a ultraviolet curable resin as the resin material, the resin layer 44 in the concavo-convex pattern corresponding to the concavo-convex pattern of the recording layer 16 was formed by optical imprinting.

In the mask layer processing step (S106), the mask layer 42 was etched by RIE using a fluorine gas.

In the recording layer firstly processing step (S108), by IBE using an Ar gas, the recording layer 16 was etched to remove the recording layer 16 by 20 nm from the top surface (down to the bottom surface of the recording layer 16). Note that in the data region, the top surface of the recording element 14 was 50 nm in width in the radial direction. Furthermore, the concave portion 18 had a radial width of 20 nm at the top surface level of the recording element 14. The etching conditions were as shown below. Note that the angle of irradiation is the angle formed between the surface of the workpiece 40 and the principal direction in which the Ar gas travels when the surface of the workpiece 40 is irradiated therewith.

Flow rate of Ar gas: 10 sccm

Pressure in chamber: 0.01 Pa

Angle of irradiation of Ar gas: 90 degrees

Beam voltage: 750 V

Beam current: 500 mA

Suppressor voltage: −400 V

In the recording layer secondly processing step (S110), also by IBE using an Ar gas, the concave portion of the recording layer 16 was irradiate with the Ar gas. Note that the seed layer 26 at the bottom of the concave portion was also removed by a trace amount. The processing conditions were as shown below. Note that after the processing, the mask layer 42 was removed by ashing using an O₂ gas.

Flow rate of Ar gas: 10 sccm

Pressure in chamber: 0.01 Pa

Angle of irradiation of Ar gas: 90 degrees

Beam voltage: 200 V

Beam current: 500 mA

Suppressor voltage: −300 V

In the filler material depositing step (S112), SiO₂ was deposited by bias sputtering in a thickness of 100 nm.

In the flattening step (S114), by IBE using an Ar gas, the excessive portion of the material of the filler portion 20 was removed.

In the protective layer forming step (S116), the protective layer 28 of DLC was deposited by CVD in a thickness of 3 nm over the recording element 14 and the filler portion 20.

In the lubricant layer forming step (S118), PFPE was applied on the protective layer 28 by dipping in a thickness of 1 to 2 nm. Note that after the application of PFPE, tape burnishing was carried out.

The magnetic property of a sample magnetic recording medium 10 obtained in this manner was evaluated as follows.

First, an external magnetic field of 15 kOe was applied to the sample in a first direction perpendicular to the surface thereof to saturate the recording layer 16 of the sample with magnetization in the first direction. After that, the application of the external magnetic field was stopped, and then the magnetization status of the sample was observed by MFM (Magnetic Force Microscopy).

Next, an external magnetic field of 20 Oe was applied to the sample in a second direction, which was opposite to the first direction and perpendicular to the surface of the sample. After that, the application of the external magnetic field in the second direction was stopped, and then the magnetization status of the sample was observed by MFM.

Likewise, while the external magnetic field in the second direction was increased in increments of 20 Oe, these steps of applying an external magnetic field to the sample in the second direction, stopping the application of the external magnetic field, and observing the magnetization status by MFM were repeatedly followed.

The level of external magnetic fields at which part of the sidewall portion 14A and the center portion 14B started magnetization reversal were interpreted as the nucleation magnetic field Hn of the respective portions. In this manner, the nucleation magnetic field Hns of the sidewall portion 14A of the recording element 14 and the nucleation magnetic field Hnc of the center portion 14B were measured. Furthermore, the level of an external magnetic fields at which approximately half of the sidewall portion 14A and the center portion 14B achieved magnetization reversal were interpreted as the coercive force Hc of the respective portions. The coercive force Hcs of the sidewall portion 14A of the recording element 14 and the coercive force Hcc of the center portion 14B were thus measured.

Next, the recording and reproducing characteristics of the sample were measured. Specifically, the measurements were made first by applying a recording magnetic field at a recording frequency of 91 MHz to only one track (a recording element 14), located at about 15 mm radially apart from the center of rotation, to record a magnetic signal thereon. After that, the magnetic signal of this track was read to measure the S/N ratio. Note that at the time of recording and reproducing operations, the sample was rotated at 4200 rpm.

Next, another magnetic signal was recorded at a recording frequency of 26 MHz on the two tracks (or recording elements 14) adjacent to the aforementioned track on both sides. After that, the magnetic signal on the aforementioned track (on which the magnetic signal was recorded at a recording frequency of 91 MHz) was reproduced again in the same conditions as those mentioned above to measure the S/N ratio again.

Then, the difference between the S/N ratios measured in this manner was calculated: the S/N ratio of the magnetic signal with a recording frequency of 91 MHz measured before the magnetic signal with a recording frequency of 26 MHz was recorded and the S/N ratio of the magnetic signal with a recording frequency of 91 MHz measured after the magnetic signal was recorded at a recording frequency of 26 MHz. The difference between the S/N ratios is thought to indicate the degree of inappropriate magnetization reversal that occurred on the track on which the magnetic signal was recorded at a recording frequency of 91 MHz, due to the recording magnetic field used to record the magnetic signal on both neighboring tracks at a recording frequency of 26 MHz.

Finally, the ratio of the number of Cr atoms in the sidewall portion 14A of the recording element 14 and the ratio of the number of Cr atoms of the center portion 14B were measured. Note that each ratio of the number of Cr atoms refers to the ratio of the number of Cr atoms to the total number of Co, Cr, and Pt atoms that constitute the sidewall portion 14A or the center portion 14B, both of which contain Cr. These measurement results obtained in this manner are shown in Table 1. Note that the specific method employed here for measuring the composition ratio of components will be described later.

TABLE 1

| | | Working | Working | Working | Working | Working | Comparative | Comparative |
|---|---|---|---|---|---|---|---|---|
| | | Example 1 | Example 2 | Example 3 | Example 4 | Example 5 | Example 1 | Example 2 |
| Center | Cr(Cu) content (%) | 18 | 18 | 18 | 18 | 20 | 18 | 20 |
| portion | Hnc(kOe) | 2.4 | 2.4 | 2.4 | 2.4 | 2.4 | 2.4 | 2.4 |
| | Hcc(kOe) | 4.8 | 4.8 | 4.8 | 4.8 | 4.8 | 4.8 | 4.8 |
| | Hnc/Hcc | 0.50 | 0.50 | 0.50 | 0.50 | 0.50 | 0.50 | 0.50 |
| Sidewall | Cr(Cu) content (%) | 10 | 0 | 0 | 0 | 0 | 18 | 20 |
| portion | Hns(kOe) | 3.0 | 3.1 | 3.1 | 3.1 | 3.3 | 2.4 | 2.4 |
| | Hcs(kOe) | 4.8 | 4.8 | 5.0 | 4.6 | 4.8 | 4.8 | 4.8 |
| | Hns/Hcs | 0.63 | 0.65 | 0.62 | 0.67 | 0.69 | 0.50 | 0.50 |
| S/N ratio | Before recording adjacent tracks | 18.0 | 18.0 | 17.8 | 18.2 | 18.0 | 18.0 | 18.0 |
| (dB) | After recording adjacent tracks | 16.9 | 17.0 | 16.8 | 17.2 | 17.2 | 15.5 | 15.5 |
| | Difference between before and | 1.1 | 1.0 | 1.0 | 1.0 | 0.8 | 2.5 | 2.5 |
| | after recording adjacent tracks | | | | | | | |

| | | | | | | | |
|---|---|---|---|---|---|---|---|
| Hns − Hnc | 0.6 | 0.7 | 0.7 | 0.7 | 0.9 | 0.0 | 0.0 |
| Hns/Hnc | 1.3 | 1.3 | 1.3 | 1.3 | 1.4 | 1.0 | 1.0 |
| (Hns/Hcs)/(Hnc/Hcc) | 1.3 | 1.3 | 1.2 | 1.3 | 1.4 | 1.0 | 1.0 |

### Working Example 2

As described in relation to the second exemplary embodiment, the magnetic recording medium 50 was prepared.

Specifically, in the recording layer firstly processing step (S108), the recording layer 16 was etched down to its bottom surface to form only the center portion 14B of the recording element 14. Note that in the data region, the top surface of the center portion 14B of the recording element 14 was 40 nm in width in the radial direction. Furthermore, the concave portion between the center portions 14B had a radial width of 30 nm at the top surface level of the recording element 14. The etching conditions were the same as those for the recording layer firstly processing step (S108) in Working Example 1.

In the sidewall portion material depositing step (S202), by sputtering, a CoPt—SiO₂ film containing no Cr was deposited to a thickness of 5 nm at the sidewall portion. More specifically, the material that had a composition formula of CO₃₀₀Pt₁₀₀SiO₂((CO₇₅Pt₂₅)₈₀ (SiO₂)₂₀) was deposited. The deposition conditions were as shown below.

Pressure in chamber: 0.5 Pa

Ar gas flow rate: 50 sccm

Source power: 500 W

Furthermore, the concave portion 18 had a radial width of 20 nm at the top surface level of the recording element 14.

A sample of the magnetic recording medium 50 was prepared with the other conditions being the same as those of Working Example 1. The sample of the magnetic recording medium 50 thus obtained was measured in the same manner as with Working Example 1 to find its magnetic properties, its recording and reproducing characteristics, and its ratios of the number of Cr atoms. The measurement results are also shown in Table 1.

### Working Example 3

In contrast to Working Example 2, a change was made to the conditions to prepare the magnetic recording medium 50. Specifically, in the sidewall portion material depositing step (S202), the pressure in chamber was set at 2.0 Pa. A sample of the magnetic recording medium 50 was prepared with the other conditions being the same as those of Working Example 2. The sample of the magnetic recording medium 50 thus obtained was measured in the same manner as with Working Examples 1 and 2 to find its magnetic properties, its recording and reproducing characteristics, and its ratios of the number of Cr atoms. The measurement results are also shown in Table 1.

### Working Example 4

In contrast to Working Example 2, a change was made to the conditions to prepare the magnetic recording medium 50. Specifically, in the sidewall portion material depositing step (S202), the chamber pressure was set at 0.1 Pa. A sample of the magnetic recording medium 50 was prepared with the other conditions being the same as those of Working Example 2. The sample of the magnetic recording medium 50 thus obtained was measured in the same manner as with Working Example 1 and the like to find its magnetic properties, its recording and reproducing characteristics, and its ratios of the number of Cr atoms. The measurement results are also shown in Table 1.

### Working Example 5

In contrast to Working Example 2, a change was made to the conditions to prepare the magnetic recording medium 50. Specifically, as the material of the recording layer 16 (the material of the center portion 14B of the recording element 14), CoCrPt—SiO₂ was replaced with FePtCu—MgO. More specifically, the material that had a composition formula of Fe₁₆₀Pt₁₆₀Cu₈₀MgO((Fe₄₀Pt₄₀Cu₂₀)₈₀ (MgO)₂₀) was deposited. Furthermore, as the material of the sidewall portion 14A of the recording element 14, CoPt was replaced with FePt—MgO that contains no Cu. More specifically, the material that had a composition formula of Fe₂₀₀Pt₂₀₀MgO((Fe₅₀Pt₅₀)₈₀(MgO)₂₀) was deposited. Next, in between the protective layer forming step (S116) and the lubricant layer forming step (S118), the sample was annealed in a temperature environment of 400° C. for 5 minutes. Note that the annealing allows the sidewall portion 14A and the center portion 14B to have a regulated L10 structure. A sample of the magnetic recording medium 50 was prepared with the other conditions being the same as those of Working Example 2. The sample of the magnetic recording medium 50 thus obtained was measured in the same manner as with Working Example 1 and the like to find its magnetic properties, its recording and reproducing characteristics, and its Cu content. The measurement results are also shown in Table 1.

### Comparative Example 1

In contrast to the aforementioned Working Example 1, the recording layer secondly processing step (S110) was eliminated. A sample of the magnetic recording medium was prepared with the other conditions being the same as those of Working Example 1. The final concavo-convex pattern had the same shape as that of Working Example 1. The sample of the magnetic recording medium thus obtained was measured in the same manner as with Working Example 1 and the like to find its magnetic properties, its recording and reproducing characteristics, and its Cr content. The measurement results are also shown in Table 1.

### Comparative Example 2

In contrast to the aforementioned Working Example 5, the sidewall portion material depositing step (S202) was eliminated. A sample of the magnetic recording medium was prepared with the other conditions being the same as those of Working Example 5. The final concavo-convex pattern had the same shape as that of Working so Example 5. The sample of the magnetic recording medium thus obtained was measured in the same manner as with Working Example 5 and the like to find its magnetic properties, its recording and reproducing characteristics, and its Cr content. The measurement results are also shown in Table 1.

As shown in Table 1, in Comparative Examples 1 and 2, the nucleation magnetic field Hns of the sidewall portion (or a portion equivalent thereto) of the recording element was equal to the nucleation magnetic field Hnc of the center portion (or a portion equivalent thereto). In contrast to this, in Working Examples 1 to 5, the nucleation magnetic field Hns of the sidewall portion 14A of the recording element 14 was greater than the nucleation magnetic field Hnc of the center portion 14E. Specifically, Hns was 1.3 to 1.4 times greater than Hnc.

Furthermore, in Comparative Examples 1 and 2, Hns/Hcs and Hnc/Hcc were equal to each other. In contrast to this, in Working Examples 1 to 5, Hns/Hcs was greater than Hnc/Hcc. Specifically, Hns/Hcs was 1.2 to 1.4 times greater than Hnc/Hcc.

Furthermore, in Comparative Examples 1 and 2, the coercive force Hcs of the sidewall portion 14A of the recording element 14 and the coercive force Hcc of the center portion 14B were equal to each other. Also, in Working Examples 1, 2 and 5, the coercive force Hcs of the sidewall portion 14A of the recording element 14 and the coercive force Hcc of the center portion 14B were equal to each other. On the other hand, in Working Example 4, the coercive force Hcs of the sidewall portion 14A of the recording element 14 was less than the coercive force Hcc of the center portion 14B. Furthermore, in Working Example 3, the coercive force Hcs of the sidewall portion 14A of the recording element 14 was greater than the coercive force Hcc of the center portion 14B, but as described above, Hns/Hcs was greater than Hnc/Hcc. In any of Working Examples 2 to 4, while the sidewall portion 14A contains no Cr, it is thought that the respective sidewall portions 14A were deposited at different chamber pressures so that the sidewall portions 14A, had a mutually different coercive force Hcs. More specifically, the higher the chamber pressure is, the shorter the mean free path of sputtered particles becomes. This allows particles to be deposited at a lower energy level. With decreasing energy levels, particles become less easy to move on the deposited film, thereby readily causing minute air gaps to be created between particles in the deposited film. This results in the exchange coupling between magnetic particles being weakened and the coercive force being increased. Working Example 3 employed a higher chamber pressure for depositing the sidewall portion 14A than Working Example 2, and thus had a greater coercive force Hcs of the sidewall portion 14A than Working Example 2. Furthermore, Working Example 4 employed a lower chamber pressure for depositing the sidewall portion 14A than Working Example 2, and thus had a less coercive force Hcs of the sidewall portion 14A than Working Example 2.

In Working Examples 1 to 5 and Comparative Examples 1 and 2, consider the S/N ratio of the magnetic signal with a recording frequency of 91 MHz measured after the magnetic signal with a recording frequency of 26 MHz was recorded on two neighboring tracks on both sides. In any of these, this S/N ratio was less than the S/N ratio of the magnetic signal with a recording frequency of 91 MHz measured before the magnetic signal with a recording frequency of 26 MHz was recorded on two neighboring tracks (the recording elements 14) on both sides. However, the differences in S/N ratio (the degrees of decrease in S/N ratio) in Working Examples 1 to 5 were considerably less than the differences in S/N ratio in Comparative Examples 1 and 2. In Working Examples 1 to 5, this is thought to be due to the fact that effects (or inappropriate magnetization reversal) on the magnetic signal with a recording frequency of 91 MHz was prevented when the magnetic signal with a recording frequency of 26 MHz was recorded on two neighboring tracks (the recording elements 14) on both sides. This is because the nucleation magnetic field Hns of the sidewall portion 14A of the recording element 14 was greater than the nucleation magnetic field Hnc of the center portion 14B. That is, it was confirmed that the nucleation magnetic field Hns of the sidewall portion 14A of the recording element 14 could be made greater than the nucleation magnetic field Hnc of the center portion 14B, thereby providing improved characteristics for recording and reproducing magnetic signals. Since a magnetic signal is recorded on each track while effects on adjacent tracks are prevented, the track pitch can be reduced to increase the radial areal density.

Furthermore, Working Example 3 had the smallest and Working Example 4 had the greatest S/N ratio of the magnetic signal with a recording frequency of 91 MHz measured before a magnetic signal with a recording frequency of 26 MHz was recorded on two neighboring tracks (the recording elements 14) on both sides. Working Example 3 provided a greater coercive force Hcs of the sidewall portion 14A than the other Working Examples. Accordingly, it is thought that the magnetization reversal of the sidewall portion 14A of a track (the recording element 14) on which the magnetic signal with a recording frequency of 91 MHz was recorded was prevented (or the magnetization reversal was insufficient), causing Working Example 3 to provide a smaller S/N ratio than the other Working Examples. On the other hand, Working Example 4 provided a smaller coercive force Hcs of the sidewall portion 14A than the other Working Examples and Comparative Examples. Accordingly, it is thought that the magnetization reversal of the sidewall portion 14A of the track (the recording element 14) on which the magnetic signal with a recording frequency of 91 MHz was recorded was accelerated (the magnetization of the recording element was sufficiently reversed across its width), allowing Working Example 4 to provide a greater S/N ratio than the other Working Examples. Therefore, in implementing adequate magnetization reversal of a target recording element, it is thought to be unfavorable that the coercive force Hcs of the sidewall portion 14A is considerably greater than the coercive force Hcc of the center portion 14B. From these discussions, to improve the recording and reproducing characteristics for magnetic signals, it is thought to be preferable to satisfy Expression (III) or (IV) in addition to Expressions (I) and (II) above.

### Working Example 6

With the same procedures as those of Working Example 2, six types of samples of the magnetic recording medium 50 were prepared including a sample with the same structure as that of the sample of Working Example 2. In addition, one type of sample was also prepared for comparison purposes. Note that the comparative sample had the same structure as that of the sample of Comparative Example 1, but was manufactured in a different manner than the sample of Comparative Example 1 was. These seven types of samples have mutually different ratios of the number of Cr atoms of the sidewall portion 14A. The six types of samples having a structure different from that of the sample of Working Example 2 were manufactured in a manner such that in the sidewall portion material depositing step (S202), a Cr target as well as a CoPt—SiO₂ target containing no Cr were employed in the vacuum chamber to adjust the ratio of the number of Cr atoms by regulating the power applied to the Cr target. The other conditions were the same as those of Working Example 2 (the ratio between the number of Co atoms and the number of Pt atoms at the sidewall portion 14A was also the same as that in Working Example 2). With the six types of samples of the magnetic recording is medium 50 and one type of the comparative sample obtained in this manner, their magnetic properties, their recording and reproducing characteristics, and their ratios of the number of Cr atoms were measured in the same manner as in Working Example 2. The measurement results are shown in Table 2. Note that the data of the rightmost is column in Table 2 indicates data for the comparative sample.

TABLE 2

| Center | Cr content (%) | 18 | | | | | | |
|---|---|---|---|---|---|---|---|---|
| portion | Hnc(kOe) | 2.4 | | | | | | |
| | Hcc(kOe) | 4.8 | | | | | | |
| | Hnc/Hcc | 0.50 | | | | | | |
| Sidewall | Cr content (%) | 0 | 5 | 8 | 10 | 12 | 15 | 18 |
| portion | Hns(kOe) | 3.1 | 3.1 | 3.0 | 3.0 | 3.0 | 2.7 | 2.4 |
| | Hcs(kOe) | 4.8 | 4.8 | 4.8 | 4.8 | 4.8 | 4.8 | 4.8 |
| | Hns/Hcs | 0.65 | 0.65 | 0.63 | 0.63 | 0.63 | 0.56 | 0.50 |
| S/N ratio | Before recording adjacent tracks | 18.0 | 18.0 | 18.0 | 18.0 | 18.0 | 18.0 | 18.0 |
| (dB) | After recording adjacent tracks | 17.0 | 17.0 | 16.9 | 16.9 | 16.9 | 16.2 | 15.5 |
| | Difference between before and | 1.0 | 1.0 | 1.1 | 1.1 | 1.1 | 1.8 | 2.5 |
| | after recording adjacent tracks | | | | | | | |

| | | | | | | | |
|---|---|---|---|---|---|---|---|
| Hns − Hnc | 0.7 | 0.7 | 0.6 | 0.6 | 0.6 | 0.3 | 0.0 |
| Hns/Hnc | 1.3 | 1.3 | 1.3 | 1.3 | 1.3 | 1.1 | 1.0 |
| (Hns/Hcs)/(Hnc/Hcc) | 1.3 | 1.3 | 1.3 | 1.3 | 1.3 | 1.1 | 1.0 |

As shown in Table 2, it was confirmed that as the ratio of the number of Cr atoms decreases, the nucleation magnetic field Hns of the sidewall portion 14A tends to increase. Furthermore, the five types of samples with a ratio of the number of Cr atoms of 12% or less have generally the same nucleation magnetic field Hns of the sidewall portion 14A. That is, it was confirmed that at a ratio of the number of Cr atoms of approximately 12%, the nucleation magnetic field Hns tends to generally saturate and increase no more.

Note that as shown in Table 2, with the comparative sample, the nucleation magnetic field Hns of the sidewall portion (or a portion equivalent thereto) of the recording element and the nucleation magnetic field Hnc of the center portion (or a portion equivalent thereto) were equal to each other. In contrast to this, with the six types of samples of Working Examples, the nucleation magnetic field Hns of the sidewall portion 14A of the recording element 14 was greater than the nucleation magnetic field Hnc of the center portion 14B. Specifically, Hns was 1.1 to 1.3 times greater than Hnc.

Furthermore, with the comparative sample, Hns/Hcs and Hnc/Hcc were equal to each other. In contrast to this, with the six types of samples of Working Examples, Hns/Hcs was greater than Hnc/Hcc. More specifically, Hns/Hcs was 1.1 to 1.3 times greater than Hnc/Hcc.

### Working Example 7

One of the six types of samples of the magnetic recording medium 50 according to the aforementioned Working Example 6 has a ratio of the number of Cr atoms of 12% at the sidewall portion 14A. In contrast to this sample, one type of sample of the magnetic recording medium 50 was prepared which had a different ratio of the number of Cr atoms at the center portion 14B. The other conditions were the same as those of Working Example 6 (the ratio between the number of Co atoms and the number of Pt atoms at the center portion 14B was also the same as that of Working Example 6). With the one type of sample of the magnetic recording medium 50 obtained in this manner, its magnetic properties, its recording and reproducing characteristics, and its ratios of the number of Cr atoms were measured in the same manner as in Working Example 5. The measurement results are shown in Table 3.

TABLE 3

| | | |
|---|---|---|
| Center | Cr content (%) | 15 |
| portion | Hnc(kOe) | 2.7 |
| | Hcc(kOe) | 4.8 |
| | Hnc/Hcc | 0.56 |
| Sidewall | Cr content (%) | 12 |
| portion | Hns(kOe) | 3.0 |
| | Hcs(kOe) | 4.8 |
| | Hns/Hcs | 0.63 |
| S/N ratio | Before recording | 17.8 |
| (dB) | adjacent tracks | |
| | After recording | 16.2 |
| | adjacent tracks | |
| | Difference between | 1.6 |
| | before and | |
| | after recording | |
| | adjacent tracks | |

| | |
|---|---|
| Hns − Hnc | 0.3 |
| Hns/Hnc | 1.1 |
| (Hns/Hcs)/(Hnc/Hcc) | 1.1 |

As shown in Table 3, the nucleation magnetic field Hns of the sidewall portion 14A of the recording element 14 was greater than the nucleation magnetic field Hnc of the center portion 14B. Specifically, Hns was 1.1 times greater than Hnc. Furthermore, Hns/Hcs was greater than Hnc/Hcc. More specifically, Hns/Hcs was 1.1 times greater than Hnc/Hcc.

Finally, a description will be made below to an exemplary method for confirming the composition ratio of components of the recording element 14 in the magnetic recording medium 10 (50).

First, the method includes stripping the lubricant layer 30 of the magnetic recording medium 10 (50), followed by coating carbon in a thickness of about 20 nm on the protective layer 28. Then, by FIB (Focused Ion Beam), a portion including the recording element 14 and the filler portion 20 is cut along a cross-section, which is in parallel to the direction of thickness and the radial direction of the magnetic recording medium, to have a thickness of about 50 nm. In this manner, a cross-section TEM sample is prepared. For example, to produce this sample, it is possible to employ FB 2100 (by Hitachi High-Technologies Corporation).

The sample obtained in this manner can be observed by TEM (Transmission Electron Microscope) and analyzed by EDS (Energy-Dispersive x-ray Spectroscopy), thereby providing composition ratios. For these measurements, it is possible to employ, for example, FE-TEM (JEM-2100F by JEOL Ltd.) or FE-STEM (HD 2000 by Hitachi High-Technologies Corporation).

### INDUSTRIAL APPLICABILITY

Various exemplary embodiments of the present invention are applicable to magnetic recording media having a recording layer in a concavo-convex pattern such as discrete track media or patterned media.

### REFERENCE SIGNS LIST

2—magnetic recording and reproducing apparatus
4—magnetic head
10, 50—magnetic recording medium
12—substrate
14—recording element
14A—sidewall portion
14B—center portion
16—recording layer
18—concave portion
20—filler portion
24—soft magnetic layer
26—seed layer
28—protective layer
30—lubricant layer
40, 60—workpiece
42—mask layer
44—resin layer
S102—starting body of a workpiece preparing step
S104—resin layer forming step
S106—mask layer processing step
S108—recording layer firstly processing step
S110—recording layer secondly processing step
S112—filler material depositing step
S114—flattening step
S116—protective layer forming step
S118—lubricant layer forming step
S202—sidewall portion material depositing step

1. A magnetic recording medium comprising:
a substrate; and
a recording layer formed over the substrate in a predetermined concavo-convex pattern with a convex portion of the concavo-convex pattern serving as a recording element, wherein
the recording layer is made of both magnetic particles containing Co, Cr, and Pt and a nonmagnetic material containing Cr present among the magnetic particles, and
the recording element has an uneven Cr distribution such that a ratio of a number of Cr atoms that constitute the recording element to a total number of Co, Cr, and Pt atoms that constitute the recording element is less at a sidewall portion of the recording element than at a center portion of the recording element.

2. The magnetic recording medium according to claim 1, wherein
the ratio of the number of Cr atoms that constitute the recording element to the total number of Co, Cr, and Pt atoms that constitute the recording element is 12% or less at the sidewall portion of the recording element.

3. A magnetic recording and reproducing apparatus comprising:
the magnetic recording medium according to claim 1; and
a magnetic head for recording and reproducing a magnetic signal on/from the magnetic recording medium.

4. A magnetic recording and reproducing apparatus comprising:
the magnetic recording medium according to claim 2; and
a magnetic head for recording and reproducing a magnetic signal on/from the magnetic recording medium.

5. A method for manufacturing a magnetic recording medium, comprising:
a sidewall material deposition step of, using a workpiece having a substrate and a recording layer formed over the substrate so in a predetermined concavo-convex pattern with a convex portion of the concavo-convex pattern serving as a center portion of a recording element, depositing a material of a sidewall portion of the recording element on the work piece to thereby form the sidewall portion on a side of the center portion, wherein
the recording layer is made of both magnetic particles containing Co, Cr, and Pt, and a nonmagnetic material containing Cr present among the magnetic particles,
the magnetic recording medium has an uneven Cr distribution in the recording element such that a ratio of a number of Cr atoms that constitute the recording element to a total number of Co, Cr, and Pt atoms that constitute the recording element is less at the sidewall portion of the recording element than at the center portion of the recording element.

6. A magnetic recording medium comprising:
a substrate; and
a recording layer formed over the substrate in a predetermined concavo-convex pattern with a convex portion of the concavo-convex pattern serving as a recording element, wherein relationships given by Expressions (I) and (II) below are satisfied;
Hnc<Hns (I), and
Hnc/Hcc<Hns/Hcs (II)
where Hns is a nucleation magnetic field of a sidewall portion of the recording element, Hnc is a nucleation magnetic field of a center portion of the recording element, Hcs is a coercive force of the sidewall portion, and Hcc is a coercive force of the center portion.

7. The magnetic recording medium according to claim 6, wherein
a relationship given by Expression (III) or (Iv) below is satisfied;
Hcc=Hcs (III), or
Hcc>Hcs (IV)
where Hcs is the coercive force of the sidewall portion, and Hcc is the coercive force of the center portion.

8. A magnetic recording and reproducing apparatus comprising:
the magnetic recording medium according to claim 6; and
a magnetic head for recording and reproducing a magnetic signal on/from the magnetic recording medium.

9. A magnetic recording and reproducing apparatus comprising:
the magnetic recording medium according to claim 7; and
a magnetic head for recording and reproducing a magnetic signal on/from the magnetic recording medium.

10. A method for manufacturing a magnetic recording medium, comprising:
a sidewall material deposition step of, using a workpiece having a substrate and a recording layer formed over the substrate in a predetermined concavo-convex pattern with a convex portion of the concavo-convex pattern serving as a center portion of a recording element, depositing a material of a sidewall portion of the recording element on the work piece to thereby form the sidewall portion on a side of the center portion, wherein
the magnetic recording medium satisfies relationships given by Expressions (I) and (II) below;
Hnc<Hns (I), and
Hnc/Hcc<Hns/Hcs (II)
where Hns is a nucleation magnetic field of the sidewall portion of the recording element, Hnc is a nucleation magnetic field of the center portion of the recording element, Hcs is a coercive force of the sidewall portion, and Hcc is a coercive force of the center portion.
